(19) United States
(12) Patent Application Publication
(10) Pub. No.: US 2007/0071198 A1
(43) Pub. Date: Mar. 29, 2007

(54) Apparatus and a method for applications of caller line identification signals

(75) Inventor: Uri Salomon, Petach-Tikva (IL)

Correspondence Address: Martin D. Moynihan, PRTSI, Inc., P.O. Box 16446, Arlington, VA, 22215, US

(73) Assignee: M.G.S. Communication Ltd., Petach-Tikva (IL)

(21) Appl. No.: 11/478,770

(22) Filed: Jul. 3, 2006

Related U.S. Application Data
(60) Provisional application No. 60/704,945, filed on Aug. 4, 2005.
(60) Provisional application No. 60/699,645, filed on Jul. 18, 2005.

(51) Int. Cl. H04M 15/06; H04M 1/56

(52) U.S. Cl. 379/142.01

(57) ABSTRACT

Apparatus for providing caller identification between a private telephone network having extensions and a public telephone network. The private network and the public network are connected through a private branch exchange. The public telephone network carries caller identification signals according to a predetermined protocol. The apparatus comprises an adaptor being operable to send caller identification between the public telephone network and the private telephone network by bypassing the private branch exchange. In a further embodiment, a voice signature is sent to the communications device on the private network in accordance with the associated caller identification. Applications for digital networks and communications devices are provided as well.

### RELATED APPLICATIONS

This Application claims the benefit of U.S. Provisional Patent Application No. 60/699,645 filed on Jul. 18, 2005, and from U.S. Provisional Patent Application No. 60/704,945 filed on Aug. 4, 2005, the contents of which are hereby incorporated by reference.

### FIELD AND BACKGROUND OF THE INVENTION

The present invention relates to an apparatus and a method for applications of caller line identification signals.

The advantage of caller identification on a telephony device, whether cellular, landline, or any other type, is widely known. A user of a telephony device generally prefers to have prior knowledge of the calling party before answering a phone call. In recent years, the public telephone network in most countries of the world supports what is generally referred to as CLI or caller line identification, which is a feature of the network protocol that is used to provide the number of the calling party.

While there are relatively few standards worldwide for implementing such a protocol on the public telephone networks, there are numerous proprietary protocols for private branch exchanges (PBX) often used in business, home, or other environments having an internal phone network with many local extensions. When such a PBX is used to route calls to a private phone network, the proprietary protocol in such an exchange may not be compatible with the CLI protocol of the network to which it is connected. Furthermore, if the PBX dates from the time before the use of the CLI function became prevalent in most public telephone networks, chances are that the PBX is not compatible with any protocol that handles the CLI function. In such a case, the individual extensions connected to such a PBX, however sophisticated they may be, will not be able to receive the caller identification function.

Replacing an otherwise fully operational PBX merely because it lacks CLI fuctionality is most often not justifiable.

Even when the CLI is passed to individual devices behind PBX networks or directly to the home in residential applications, the user must have the handset with him or her to visually read the displayed CLI. Further, particularly in a household environment where a telephone number is typically used by an entire household with multiple members, each member of the household needs to visually look at the display on the phone to determine if he or she is the intended recipient of the call. As a result of the above drawback, cellular devices are often used instead of landline telephones in order to reach a specific person, as most cellular devices are personal rather than dedicated for use by several people. Therefore, there is an unmet need for, and it would be highly useful to have, a system and a method that overcomes the above drawbacks.

### SUMMARY OF THE INVENTION

According to one aspect of the present invention there is provided an add-on device for passing caller identification signals between a public telephone network and a private telephone network having extensions, said public telephone network carrying said caller identification signals according to a predetermined protocol, wherein said private network and said public network are connected through a private branch exchange, said private branch exchange being unable to transport said caller identification according to said predetermined protocol, said add-on device comprising:

an adaptor for connection between at least one incoming line of said public telephone network and said extensions, there through to send said caller identification between said public telephone network and said private telephone network, thereby to bypass said private branch exchange.

According to another aspect of the present invention there is provided a method for providing caller identification signals between a public telephone network carrying said caller identification signals according to a predetermined protocol and a private telephone network having extensions, wherein said private network and said public network are connected through a private branch exchange, said private branch exchange being unable to transport said caller identification signals according to said predetermined protocol, said method comprising:

sending caller identification between said public telephone network and said private telephone network by bypassing said private branch exchange.

According to an additional aspect there is also provided an apparatus for association with an incoming call line and for providing caller voice identification to a communications device, said apparatus comprising:

a database for associating caller identification of an incoming call with a voice signature; and

an output device associated with said database configured to output said associated voice signature to said communications device.

According to an additional aspect there is also provided an add on device for adding to a conventional telephone, comprising a ring detector, amplifier, and loudspeaker, wherein said ring detector is operable to enable said amplifier, said amplifier being connected to said loudspeaker thereby to send a voice signal to said loudspeaker during a ring period.

According to an additional aspect there is also provided a telephone with a loudspeaker, wherein said telephone is modified to send voice signals received during a ring period to said loudspeaker for output.

According to an additional aspect there is also provided an apparatus for providing caller voice identification to a first digital communications device, said device being located on a digital network, said apparatus comprising;

a recording device for inserting a recorded voice signature into a message in accordance with a digital communications protocol,

a sending mechanism associated with said first digital communications device for sending said message to a second digital communications device in accordance with said digital communications protocol.

According to an additional aspect there is also provided an apparatus for receiving caller voice identification at a digital communications device, said device being located on a digital network, said apparatus comprising;

a detecting device configured to detect a voice signature in a call having a digital communications protocol; and

an output device configured to output said detected voice signature to said communications device.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected stages of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a generalized embodiment of the present invention.

FIG. 2 shows a more detailed embodiment of FIG. 1.

FIG. 3A is a simplified diagram showing the CLI adaptor comprising a digital recording circuit.

FIG. 3B is a simplified diagram showing the CLI adaptor comprising a CLI detector/regenerator.

FIG. 4 is a simplified flow chart showing the operation of the embodiment of FIG. 2.

FIG. 5 is a generalized embodiment of the present invention for the provision of voice identification together with the CLI to a communications device.

FIG. 6 is a diagram showing the sequence of ring signals together with the CLI and voice ID signals that are sent to a communications device.

FIG. 7 is a particular embodiment of the present invention for the provision of voice identification together with the CLI to a communications device using a CLI compatible PBX.

FIG. 8 is a particular embodiment of the present invention in which a PBX incompatible with CLI is used together with a CLI adaptor and voice ID signal database.

FIG. 9 represents a preferred embodiment of the present invention wherein a ring detecting device connected to a communications device controls an amplifier through which the incoming voice ID signal is routed.

FIG. 10A is an embodiment of the invention using digital networks and communications devices operating on digital communications protocols.

FIG. 10B is an alternative embodiment of the invention using digital networks and communications devices operating on digital communications protocols.

FIG. 11 is a simplified schematic diagram of a digital message arranged in packets and containing a voice signature in one of the several packets comprising the message.

### DESCRIPTION OF THE PREFERRED EMBODIMENTS

The present embodiments disclose a device for connecting to a private branch exchange (PBX) in order to route caller line identification (CLI) signals to a private network behind such an exchange. These embodiments have particular application to PBX systems that are incapable of receiving and transmitting CLI information or are incompatible with the local network format for CLI information.

In further embodiments, voice recordings are associated with caller identification signals and are passed on to end communications devices. The end devices are configured so as to process and play the voice recordings received with the CLI. Alternatively an add-on device is provided which is able to identify and play the voice recordings received with the CLI. This voice recording may be referred to as talking caller line identification (TCLI).

The embodiments discussed herein have applications as well to home telephone networks with communications devices possibly at several extensions. The home network is typically connected through a copper wire pair to a local exchange, which in turn is connected to trunk lines of the PSTN. In such a case, a PBX is not typically used. Instead, incoming calls arriving at a junction box at the home are automatically sent to all extensions in the home. An add on device, which generates the TCLI from CLI information in the call, may be attached to the copper wire pair prior to such a junction box thus providing the TCLI to the extensions in the home. Such an embodiment is discussed below.

In the case of a private network at a business or other non-home multi-extension private network, the connection to the public telephone network is typically carried out through a PBX or private branch exchange situated at the business site. That is to say, several communications devices are connected to a PBX, each communication device comprising a separate extension with an associated extension number. When an incoming call arrives at the PBX, the call is answered and preferably a prerecorded introductory message is heard by the caller. At this point, the caller either is prompted, possibly from a list read out to the user in the introductory message, or initiates the dialing of an extension number. Similarly, the PBX routes outgoing calls originating from any one of the extensions on the private network to a trunk line of the public network.

In many cases, the PBX is a legacy PBX which is unable to pass the CLI information. A PBX of this type predates the prevalent usage in public telephone networks of protocols passing the CLI information with a call. Alternatively, the legacy PBX does have the ability to pass the CLI but does so in accordance with a protocol other than that being used by the local network. In either of the above cases the CLI is lost at the PBX and is not passed on to the individual extensions.

The present embodiments thus provide a caller identification or CLI adaptor unit connected to a PBX unit for bypassing the PBX unit in order to send the CLI between the PSTN and the appropriate extensions.

In a preferred embodiment, the CLI adaptor unit contains a database of voice recordings associated with various telephone numbers. The database identifies the CLI of an incoming call, and matches the CLI with the appropriate voice recording. This voice recording together with the CLI is output to the appropriate extension on the private network. In a still further embodiment, particularly in residential applications wherein incoming calls are routed to all extensions, the voice recording together with the CLI is output with the call to all extensions in the house through use of the apparatus herein described.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

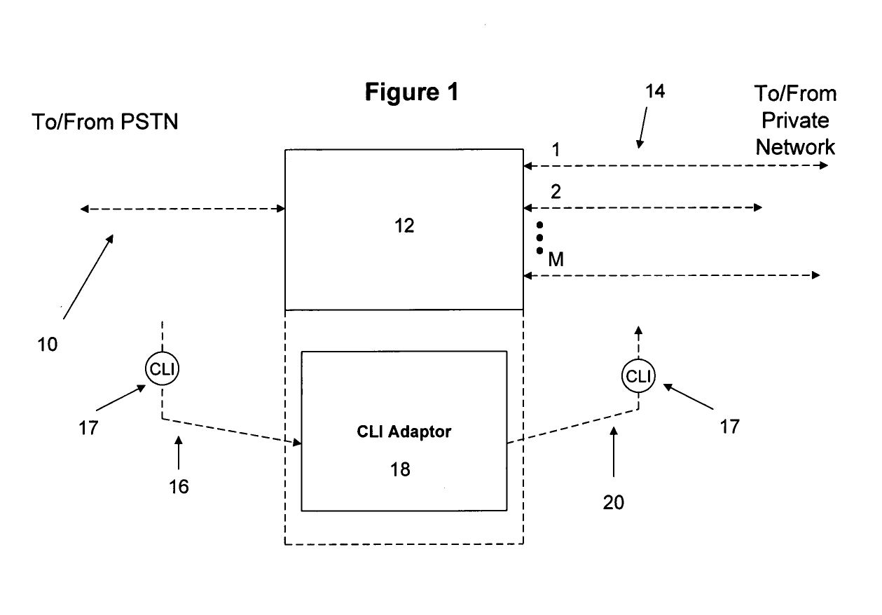

Reference is made to FIG. 1, which is a simplified diagram illustrating a generalized embodiment of the present invention. An incoming call arrives on telephone line 10 from the public telephone network and enters private branch exchange (PBX) 12. The PBX switch has connections to preferably a multiplicity of M extensions on a private network 14. Each extension typically has a communications device, such as a telephone or modem. The M extension lines carry calls from the PBX to the communications devices and visa versa

The incoming call is sent through the PBX 12, which routes the call on an appropriate one of M extension lines to an end communications device. As the PBX switch is incapable of passing CLI information in the incoming call, a CLI adaptor 18 is added on to the PBX. The CLI adaptor bypasses such an exchange in order to supply the extensions in the private network with the CLI information. The CLI adaptor has a connection 16 to telephone line 10 on which an incoming call arrives at the PBX 12. The telephone line is typically a trunk line of the PSTN. Through connection 16, the CLI information 17 is extracted to the CLI adaptor. Furthermore, connection 20 links between the CLI adaptor and the M extension lines on the private network 14. The adaptor thus extracts and subsequently sends forward, on connection 20, the CLI information 17 to one or multiple extensions on private network 14. Thus, the CLI adaptor acts as a bypass for the CLI signal from the PSTN to the private network.

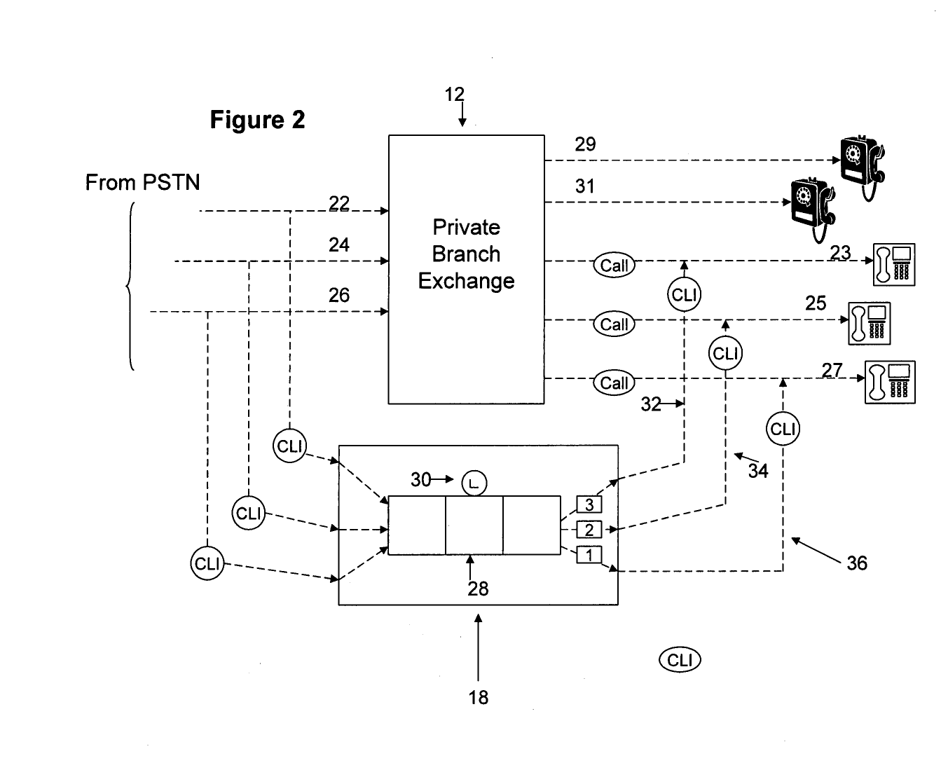

Reference is now made to FIG. 2, which shows a more detailed embodiment of FIG. 1. Parts that are the same as in FIG. 1 are given the same reference numerals and are not referred to again except as necessary for an understanding of the present embodiment. In the embodiment of FIG. 2, we now consider an example in which three incoming calls, 22, 24, and 26, are received in quick succession at legacy PBX 12. As in FIG. 1, the PBX is not capable of receiving the CLI. Thus, CLI adaptor 18 extracts the CLI information from the incoming calls and places them in buffer 28 for temporary storage. The CLI adaptor extracts the CLIs in the order received from the PSTN. The CLI has thus been temporarily extracted from the call itself.

When the incoming call is answered by the PBX, a recording is preferably played requesting the caller to enter a desired extension from a list read out by the recording or otherwise known to the caller. The PBX processes the caller input and then transfers the call to one of extensions 23, 25, and 27 on the private network side of the PBX.

When the call exits the PBX and is passed to the appropriate extension, the CLI, previously extracted from the call, is rejoined with the correct call. Thus, the CLI adaptor monitors all extension lines 23, 25, and 27 through respective connections 32, 34, and 36, and detects the next active extension at defined time delays. The defined time delays are preferably timed from the moment the call is received at the PBX.

Preferably, the defined time delay is controlled by timer 30 through appropriate programmable hardware or software. After each time delay, connections 32, 34, and 36 probe the extension lines to detect a next active extension. The next active extension is the extension currently receiving a call passed from the PBX. The call's CLI, previously copied to the CLI adaptor and now presumed to be positioned at the buffer exit, is preferably sent by the CLI adaptor to the detected next active extension. The communications device on the requested extension thus receives the call from the PBX together with the CLI presumed to correspond to the caller.

The CLI is preferably sent in a first in first out order, wherein the first CLI received at the CLI adaptor is the first to be sent to a next active extension after a defined time interval. The next active extension is detected by the CLI adaptor, preferably by measuring voltages of all extensions connected thereto. In an alternative embodiment, a timer is not provided and the adaptor simply sends the CLI at first next-active extension detection to the appropriate extension.

Finally, extensions 29 and 31 are not CLI enabled and therefore are not connected to the CLI adaptor.

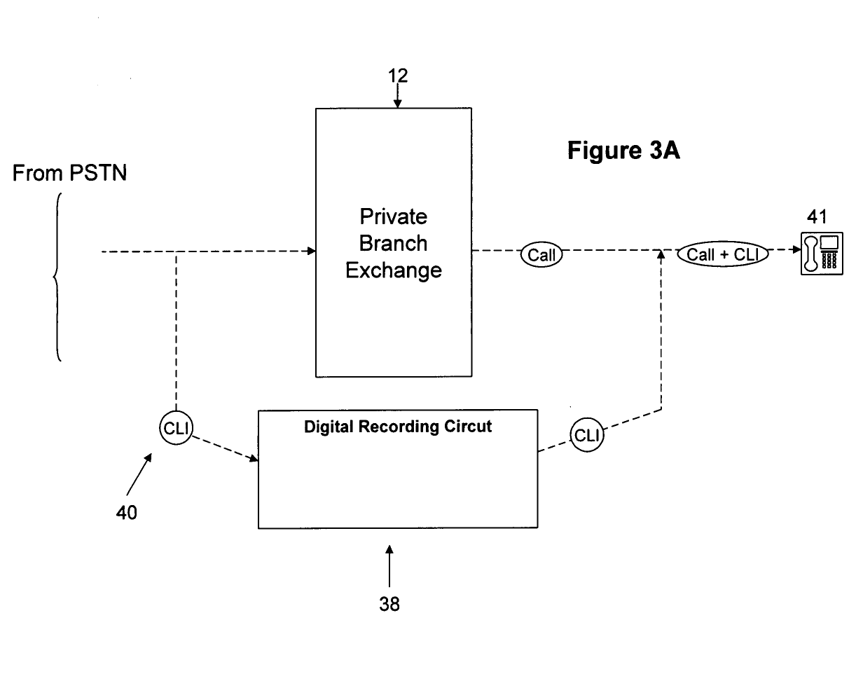

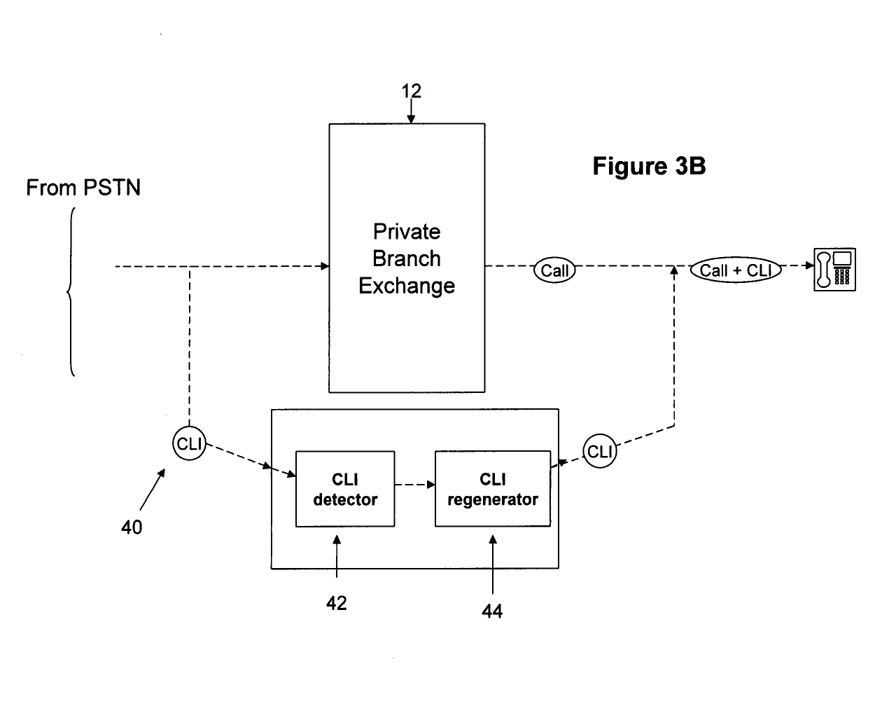

Reference is made to FIG. 3A, which is an embodiment in which the CLI adaptor comprises a digital recording circuit 38. There are several CLI protocols used in countries throughout the world. Many countries do indeed use identical, well known protocols, but others have adopted less widely used protocols. The CLI adaptor in the present embodiment is capable of transmitting the CLI used in virtually any protocol, since the adaptor is simply a digital recording chip, preferably containing memory, for recording the CLI as it is extracted from the incoming call. The CLI is then subsequently passed onwards to the extensions. The digital recording device may not have any prior knowledge of the protocol at all nor be able to understand the protocol, and nonetheless it is capable of transmitting the CLI from the PSTN to the private network side of the PBX. As seen in FIG. 3A, CLI 40 is copied to the digital recording circuit 38, and sent on, preferably after a time delay, to extension 41. Thus, extension 41 receives the call together with the CLI.

Reference is now made to FIG. 3B, which is a simplified diagram showing an alternative embodiment in which the CLI adaptor comprises a CLI detector 42 and regenerator 44. Such an embodiment may be used where the PBX does have the ability to pass the CLI, but does so in accordance with a protocol different to that used by the PSTN to which it is attached. The protocol used by the PSTN to handle the CLI is of one type, and the protocol used by the PBX is of a second type. For instance, a PBX manufactured in one country, with a first protocol, may be used in a second country whose PSTN utilizes a different protocol for CLI. The CLI data 40 entering the detector unit 42 is detected according to a first protocol, say that of the PSTN. The CLI is sent from the detector unit to a regenerator unit 44, which encodes the CLI data according to a second protocol, say that utilized by the end devices interfacing with the PBX. Therefore, the adaptor unit is capable of transforming or decoding the entering CLI from one protocol to another protocol.

The detector/regenerator unit typically comprises a processing element that is capable of processing the actual protocol handling the CLI. That is to say, the detector recognizes the protocol of the local public network and is capable of reading the CLI information. After the CLI info is sent from the detector to the regenerator, the regenerator reconstructs the CLI on the extensions side and, at the appropriate time, passes it to the appropriate extension or multiple extensions as described above.

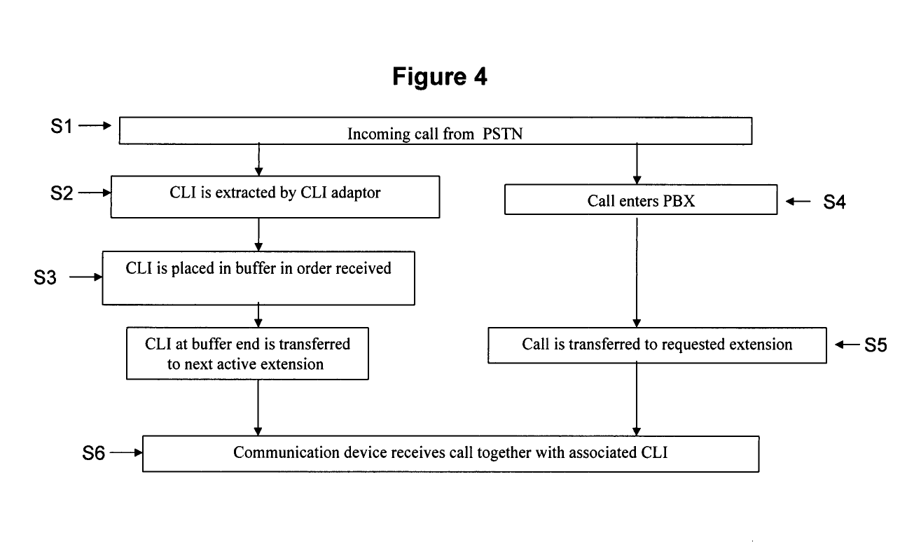

Reference is now made to FIG. 4, which is a simplified flow chart showing the operation of a device according to the embodiment of FIG. 2. In stage S1, an incoming call is received from the PSTN. In stage S2 the CLI is extracted by the CLI adaptor. In stage S3, at the CLI adaptor, the CLI information is placed in a buffer in the order received. S4 is parallel to stage S2. In S4, the incoming call enters the PBX 12. The PBX is unable to pass the CLI data. The call itself without the CLI is routed to the extension input by the caller in stage S5. When the call is placed on the appropriate extension line by the PBX, the CLI adaptor outputs the CLI number to the next active extension, as explained above, such that the communication device receives the call together with the associated CLI, seen in step S6.

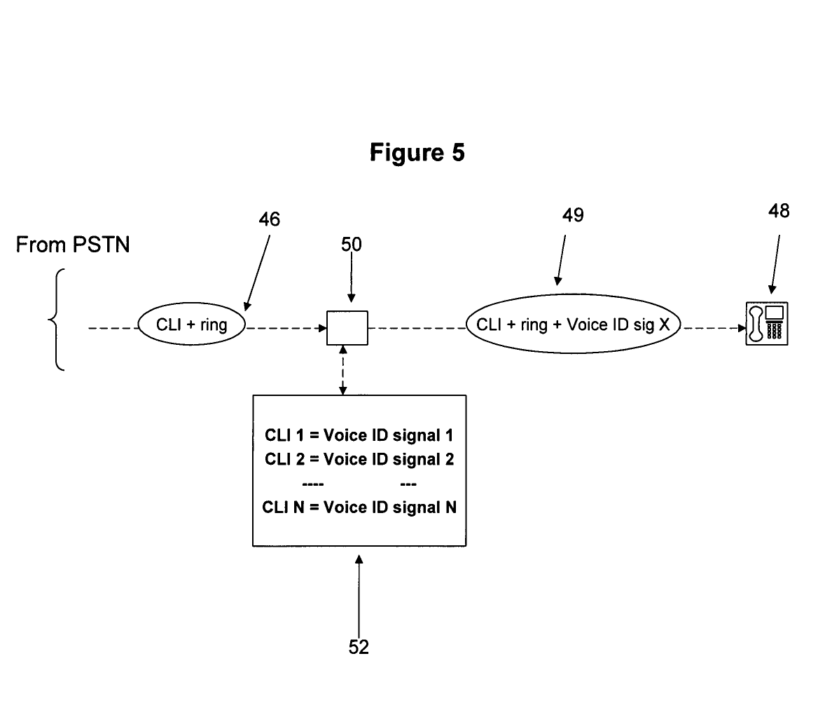

Reference is made to FIG. 5, which is a generalized embodiment of the present invention for the provision of voice identification together with the CLI to a communications device 48. In the present embodiment, a database 52, preferably a PC or a device supported by a PC, is provided that stores voice signals associated with telephone numbers. The voice signal preferably contains the name of the person having a particular telephone number, but may contain any other voice recording that aids a person receiving a call in identifying the caller. As stated above, this voice signal is referred to herein as TCLI, or Talking Caller Line Identification.

The database 52 and an associated CLI processing device 50 in the present figure may have various configurations.

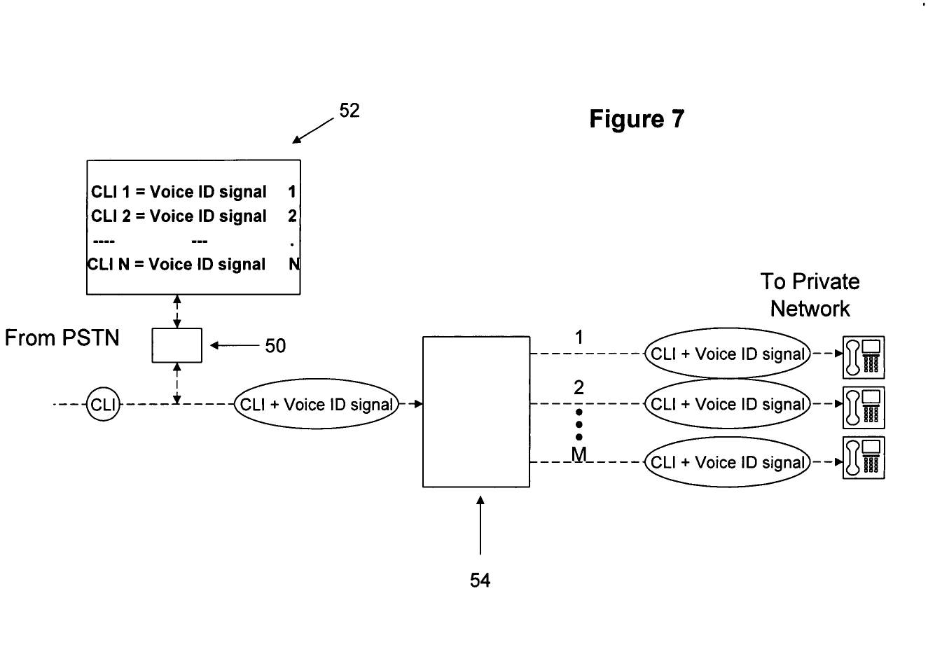

One possibility occurs in the residential framework, as seen in FIG. 7, wherein the database and processing device comprise an add on device that may be connected at or prior to a junction box at which the line is split into separate extensions. The TCLI is added to the ring and CLI signals as they enter the home using the add on device in the present embodiment.

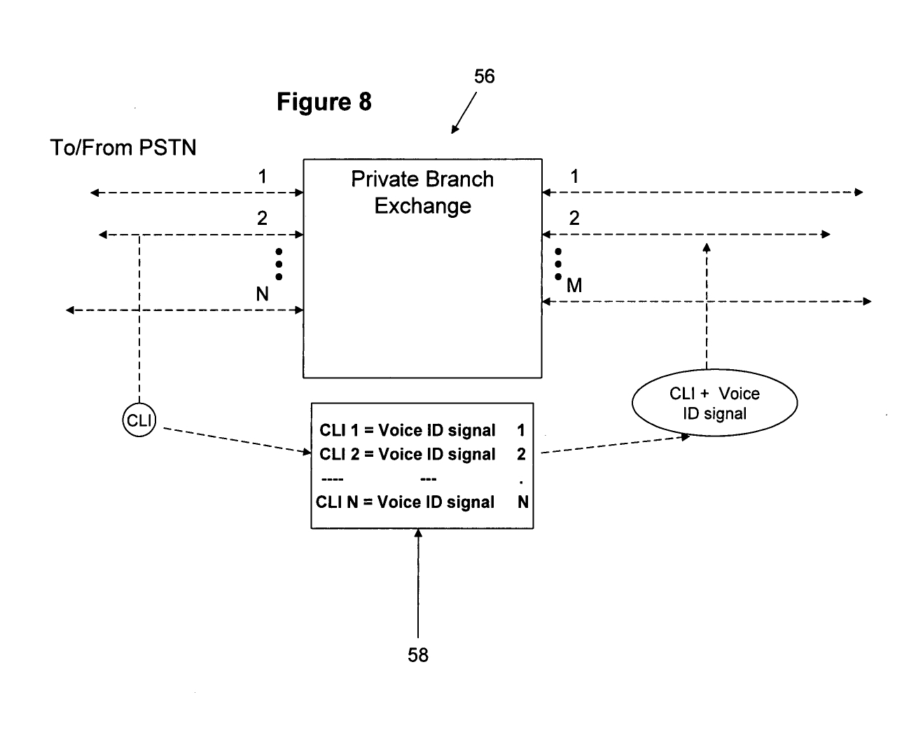

A further possibility is that where the add on device is added to the PBX unit as seen below in FIG. 8.

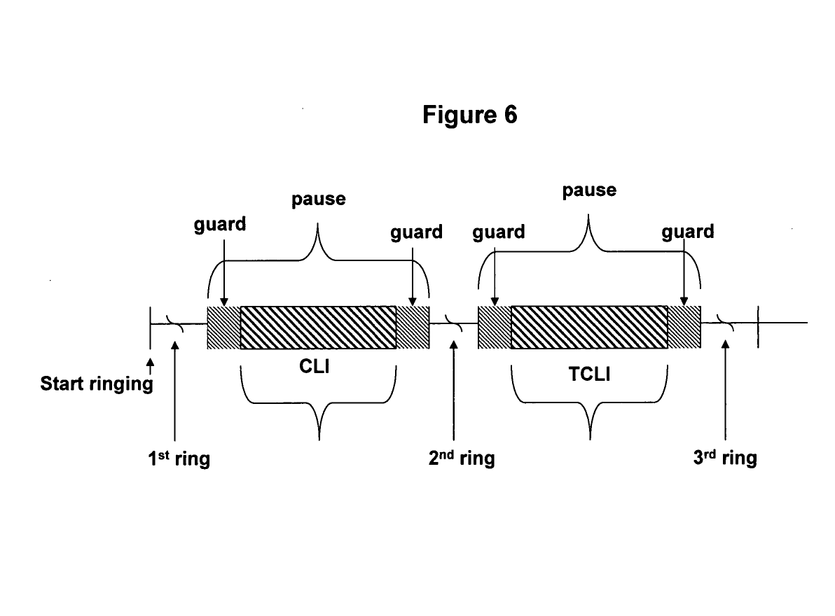

The general operation of the database and processing device in the figure is as follows. The CLI of an incoming phone call 46 to the communications device is copied by the processing device and sent to the database while the ring signal and CLI continue on through processing device 50 to the communications device 48. At the database, the CLI, representing a telephone number, is matched with the numbers stored on the database to find a prerecorded voice signal corresponding to that telephone number. If no matching number is found in the database, a default voice signal may be associated as the TCLI. As stated, the TCLI is preferably a voice recording of the name of the caller, but may be a set of audible numbers, or other voice recording that identifies the caller. The TCLI is returned by the database and continues on to the communications device, arriving at the communications device subsequent to the ring and CLI signal, as explained below in FIG. 6. The overall signal is indicated by 49. Upon reaching the communications device, the TCLI is heard through a speaker or other device installed on the communications device. The ring signal is heard through a ringer or alternatively through a speaker, in the normal way, depending on the kind of telephone, while the CLI is sent to the display.

In a preferred embodiment, the database and processing device are contained in one unit. The processing device is preferably a simple switch, with appropriate software compatible with the call protocol, enabling the processing device to recognize the CLI within the call signal. The above described database is preferably updateable.

Reference is now made to FIG. 6, which shows the sequence of ring signals together with the CLI and voice identification signals that are sent to a communications device by the output device of the voice ID database. Typically, a telephone call is preceded by ring signals separated by pauses between the rings. Before and after each ring, typically a guard time is inserted into the signal to ensure that noise or other signals do not interfere with the ring. The present embodiment utilizes the gap of unused time between the guard times to transmit both the CLI and the TCLI, as explained below.

The figure shows the standard three ring system of the Bellcore specification which is typically used on telephone networks. A pause occurs between the first and second ring signal and between the second and third ring signal, the pauses being equal to each other in duration. Each pause is preferably three seconds according to the above specification but may be longer or shorter depending on the telecommunications protocol.

In general, during the pause interval between the first and second ring, the CLI data is sent to the communications device, while according to the preferred embodiments, during the pause interval between the second and third rings the TCLI is transmitted to the device. The transmission time of the CLI and TCLI signals comprises most but not the entire pause interval between ring signals. Thus for example, the CLI or TCLI duration may be 2.5 seconds out of a 3 second pause interval between the rings. The rest of the interval is typically occupied by the above mentioned guard times before and after the ring signals.

Reference is made to FIG. 7, which is a simplified diagram illustrating the provision of voice identification (TCLI) together with the CLI in a residential environment. The figure shows an embodiment wherein the database and extractor of FIG. 5 are attached to a copper wire pair entering a junction box 54 in a residential environment. The junction box passes all entering signals to one or more of M extensions leading to communications devices on the residential network. The database 52 and extractor 50 may conveniently be attached to the copper wire pair entering the junction box, at a point lying just prior to the box. Processing device or extractor 50 copies and sends the incoming CLI to database 52 for voice signal ID (TCLI) association in the same manner as described in FIG. 5. Database 52 is preferably updatable, and possibly a simple address book in a PC, as explained above. The associated voice signal ID is then sent back to the extractor from the database and output from the extractor to the junction box. In the present embodiment, the junction box 54 outputs the CLI together with the matching TCLI directly to all of the extensions. The TCLI arrives following the CLI as seen in FIG. 6 above, between the second and third ring signals.

Reference is now made to FIG. 8, which represents a particular embodiment of the present invention in which a PBX incompatible with the local network's CLI protocol is used together with a CLI adaptor 58 having a voice identification signal database. FIG. 8 shows a PBX 56 in which calls received from the PSTN are sent to M extensions on a private network. The PBX routes the calls from the PSTN to the appropriate extension, either automatically or based on a user input extension number, possibly in the corporate environment. However, the CLI itself is not able to be passed on by the PBX and therefore the CLI adaptor module 58 having an associated voice identification signal database is attached thereto. The voice identification database associates a voice recording with a received CLI. That is to say, each telephone number in the voice identification database has an associated voice recording stored therein. This database is preferably updateable. When the CLI is received by the module 58, the CLI signal is matched with a stored telephone number and voice recording. Thus, the CLI adaptor/voice ID database outputs to the appropriate extensions on the private network a signal containing both the CLI as well as the associated voice recording. The next active extension to which are output the CLI and TCLI is preferably determined as explained in FIG. 2.

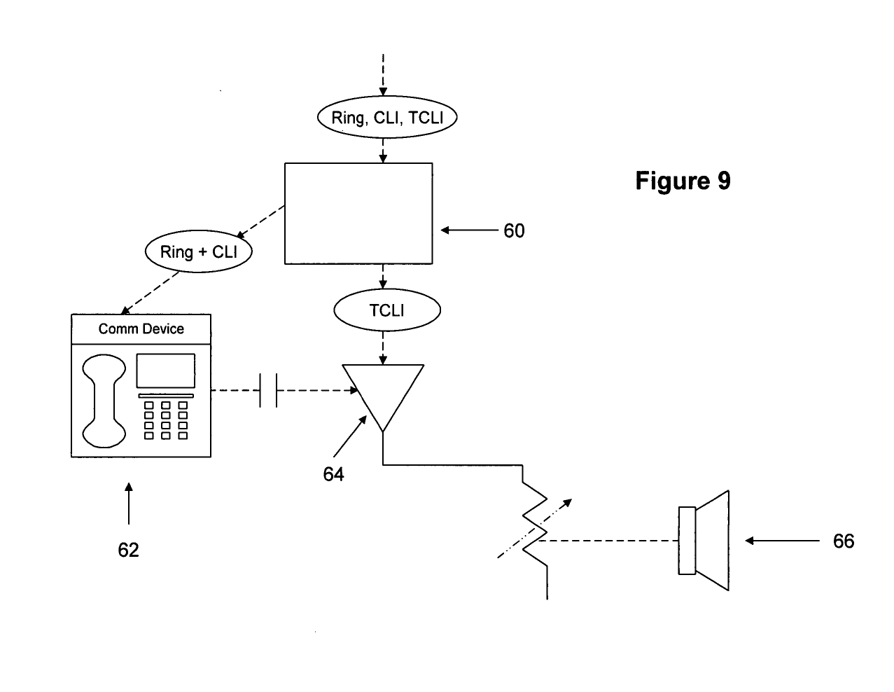

Reference is made to FIG. 9, which represents a preferred embodiment of the present invention illustrating how the ring, CLI, and TCLI signals arrive at a communications device. Ring detecting device 60 is attached to communications device 62 and amplifier 64. The ring detecting device passes the ring signal and CLI to the communications device. Communications device 62 has a ringer that can play the tone of the ring signal received but is not capable of processing and playing voice. Therefore, a separate loudspeaker 66 is attached through amplifier 64 to ring detecting device 60 to play the TCLI signal. The voice signal (TCLI) is passed directly to the input of amplifier 64. Amplifier 64 is powered by the ring signal and amplifies and sends the TCLI signal to the loudspeaker 66 specifically when the ring is active. The CLI is processed by a simple processor on communications device 62 and displayed on a number display screen. As explained, when ring detector 60 receives a ring signal, it sends power through power connection 61 to the amplifier 64, activating the amplifier so that the voice signal is amplified and can be heard on the speaker 66. The voice signal heard at the speaker is preferably the voice recording retrieved from the database and thus typically the name of the caller, but as mentioned above, may be any identifying voice recording. The transmission of the voice signal is preferably carried out between the second and third ring signals.

Alternatively, communications device 62 is a speakerphone with an internal loudspeaker having the ability to play both ring tones and voice signals. In such devices, the ring and voice parts of the signal are routed to the loudspeaker, and, a simple software modification may be made to the loudspeaker in such a speakerphone to accommodate the voice signal coming in during the ring sequence. In other words, both the ring signal and voice signal are routed to the speaker on the speakerphone. Other more advanced phones may support the TCLI without any software modification.

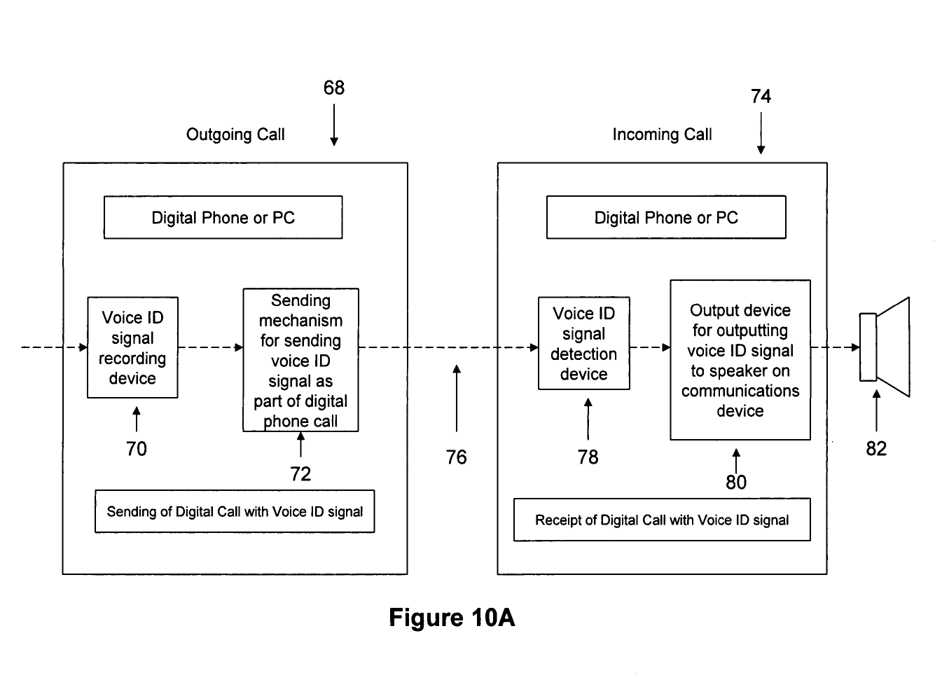

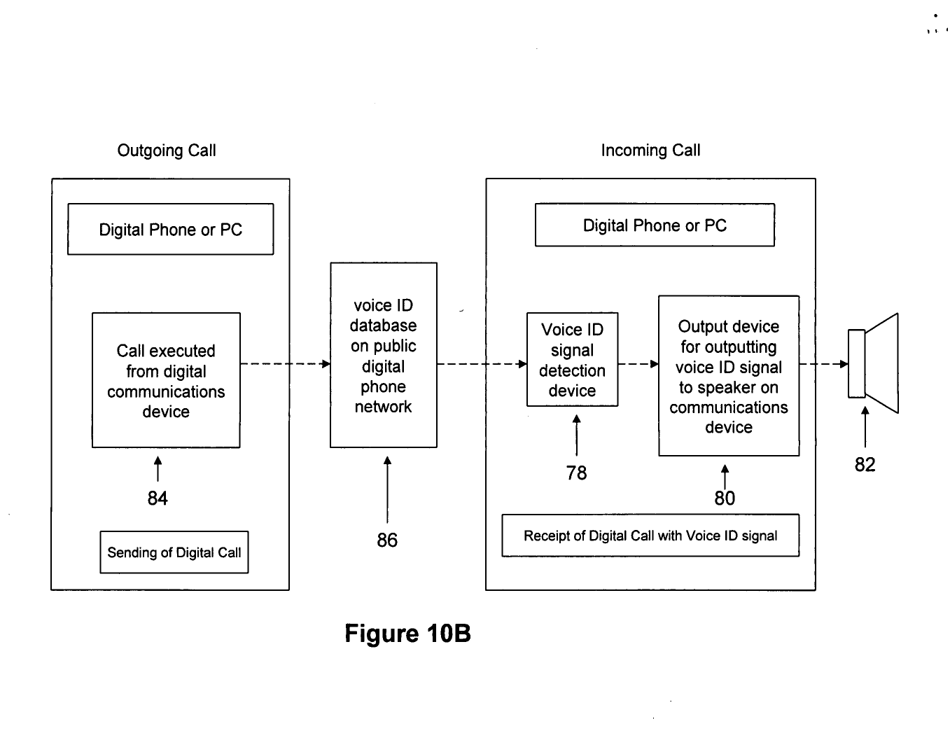

Reference is made to FIG. 10A which represents an embodiment of the invention using digital networks and communications devices operating on digital communications protocols. A first digital communications device 68 at the sender is provided with a voice signature recording device 70, preferably a software program. The recording device serves to insert a recorded voice signature into a call in accordance with a digital communications protocol. The protocol typically involves packet switched networks and each call is typically comprised of two distinct parts: control packets and data transport packets. Control packets include features and each feature is supported by a specified field into which data representing the feature is inserted. Such fields include the destination telephone number, negotiation of voice encodings, etc.

A sending mechanism 72 is further connected to the first communications device and configured to send the digital message containing a voice signature to a second digital communications device 74 through a digital network 76. Once received at the second communications device, a voice signature detection device 78 is provided to receive the digital call. The detection device contains software and/or hardware suited for the network protocol. For example, in the Channel Associated Signaling or CAS protocol, it is easy to provide the voice signature prior to the ring signal since the audio channel is allocated prior to the ring. This is true in Primary Rate Interface (PRI) standard or the Basic Access (BA) standard. On the other hand, in an alternative protocol such as Voice over IP (VoIP), the voice signature is transmitted to a terminal or gateway during call set up according to the protocol. Possible applications of the apparatus with VoIP include the H.323 standard and the Session Initiation Protocol (SIP) standard. The voice signature is sent from the voice signature detecting device 78 to an output device 80 for sending the voice signal to speaker 82.

Reference is made to FIG. 10B, which illustrates a parallel embodiment to FIG. 10A involving digital networks and communications devices operating on digital communications protocols. In FIG. 10B, the database of voice signatures is found at servers on the public network, such that subscribers to digital communications services can record and save voice recordings on the public network database 86. In such a case, when a phone call is placed from the subscriber's digital device 84, the call is sent through the digital network to the intended destination. The call is routed through the database 86 on its way to the destination, in order to receive packets containing the voice signature. Once the voice signature is added to the digital phone call, the remainder of the embodiment is as seen in FIG. 10A.

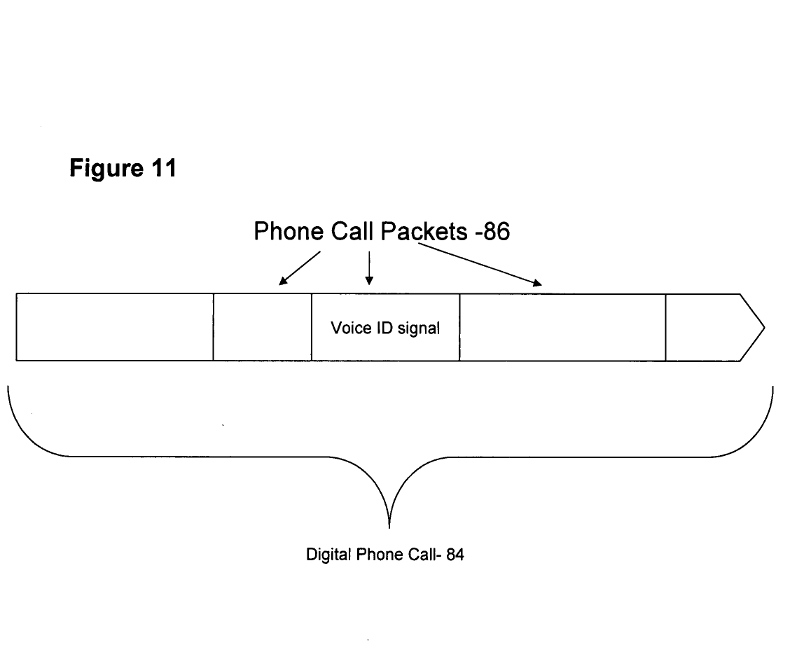

Reference is made to FIG. 11, which is a simplified diagram of a digital message containing a voice signature in one of several packets comprising the message. The digital phone call 84 is comprised of packets 86. Each packet is comprised of bytes containing control information or actual data to be transported. One packet is preferably dedicated for the voice signature information. When the packet is received at the voice signature detection device 78 at the receiving end of a digital phone call, this detection device is configured to recognize the point within the digital message that contains the voice signature data and pass it on to the output mechanism 80 seen in FIGS. 10A and 10B.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An add-on device for passing caller identification signals between a public telephone network and a private telephone network having extensions, said public telephone network carrying said caller identification signals according to a predetermined protocol, wherein said private network and said public network are connected through a private branch exchange, said private branch exchange being unable to transport said caller identification according to said predetermined protocol, said add-on device comprising:
an adaptor for connection between at least one incoming line of said public telephone network and said extensions, there through to send said caller identification between said public telephone network and said private telephone network, thereby to bypass said private branch exchange.

2. The add-on device of claim 1, wherein said adaptor is operable to send said caller identification from said public telephone network to a next active extension on said private telephone network, said adaptor being configured to detect said next active extension on said private network for sending said caller identification.

3. The add-on device of claim 2, wherein said adaptor is configured to send said caller identification to said next active extension after a defined minimum time delay in accordance with an associated timer.

4. The add-on device of claim 2, wherein said adaptor is configured with a queue for storing said caller identification prior to sending said caller identification to said next active extension.

5. The add-on device of claim 4, wherein said adaptor further is associated with a timing device for defining a minimum time delay after which said caller identification is sent from said queue.

6. The add-on device of claim 1, wherein said adaptor comprises a digital recording circuit configured to receive said caller identification of an incoming call from said public telephone network and send said caller identification to an extension on said private telephone network.

7. The add-on device of claim 1, wherein said adaptor comprises a caller identification detector and regenerator configured to detect said caller identification of an incoming call from said public telephone network and regenerate said caller identification on an extension on said private telephone network.

8. The add on device of claim 7, wherein said detecting caller identification is according to a first communications standard, and said regenerating caller identification on said extension is according to a second communications standard.

9. The add-on device of claim 1, wherein said adaptor is configured for installation on an existing private branch exchange, thereby to upgrade said private branch exchange.

10. A method for providing caller identification signals between a public telephone network carrying said caller identification signals according to a predetermined protocol and a private telephone network having extensions, wherein said private network and said public network are connected through a private branch exchange, said private branch exchange being unable to transport said caller identification signals according to said predetermined protocol, said method comprising:
sending caller identification between said public telephone network and said private telephone network by bypassing said private branch exchange.

11. An apparatus for association with an incoming call line and for providing caller voice identification to a communications device, said apparatus comprising;
a database for associating caller identification of an incoming call with a voice signature; and
an output device associated with said database configured to output said associated voice signature to said communications device.

12. The apparatus of claim 11, configured for association with a private branch exchange.

13. The apparatus of claim 11, configured for a home environment having a plurality of extensions.

14. The apparatus of claim 11, wherein the incoming call comprises at least three ring signals, and said output device is configured to output said associated voice signature between a second and third of said ring signals.

15. The apparatus of claim 11, wherein said database comprises an updatable address book.

16. An add on device for adding to a conventional telephone, comprising a ring detector, amplifier, and loudspeaker, wherein said ring detector is operable to enable said amplifier, said amplifier being connected to said loudspeaker thereby to send a voice signal to said loudspeaker during a ring period.

17. A telephone with a loudspeaker, wherein said telephone is modified to send voice signals received during a ring period to said loudspeaker for output.

18. An apparatus for providing caller voice identification to a first digital communications device, said device being located on a digital network, said apparatus comprising;
a recording device for inserting a recorded voice signature into a message in accordance with a digital communications protocol,
a sending mechanism associated with said first digital communications device for sending said message to a second digital communications device in accordance with said digital communications protocol.

19. The apparatus of claim 18, wherein said recording device is located on a database associated with a server on the public digital phone network.

20. The apparatus of claim 18, wherein said recording device is located on a home telephony device connected to the public digital phone network.

21. The apparatus of claim 18, wherein said sending mechanism is configured to send said voice signature prior to a ring signal.

22. The apparatus of claim 18, wherein said sending mechanism is configured to send said voice signature during set up of said digital telephone call.

23. An apparatus for receiving caller voice identification at a digital communications device, said device being located on a digital network, said apparatus comprising;
a detecting device configured to detect a voice signature in a call having a digital communications protocol; and
an output device configured to output said detected voice signature to said communications device.
